(19) United States
(12) Patent Application Publication
(10) Pub. No.: US 2018/0330338 A1
(43) Pub. Date: Nov. 15, 2018

(54) PREDICTIVE MAINTENANCE

(71) Applicant: Diversey, Inc., Elmwood Park, NJ (US)

(72) Inventors: David John Holden, Utrecht (NL); Erik Gordon Miller, Scotts Valley, CA (US); Andrew John Cocking, Ben Lomond, CA (US); Bert-ten Voorden, Elmwood Park, NJ (US); Michael A. Steed, Santa Cruz, CA (US); Timothy James Waldowski, Santee, CA (US); Karnika Goel, Den Haag (NL)

(21) Appl. No.: 15/775,183

(22) PCT Filed: Nov. 8, 2016
(86) PCT No.: PCT/US2016/060882

§ 371 Date: May 10, 2018

Related U.S. Application Data
(60) Provisional application No. 62/254,534, filed on Nov. 12, 2015.

(51) Int. Cl. G06Q 10/00; G06N 5/04; G01M 99/00; G06Q 30/06

(52) U.S. Cl. CPC G06Q 10/20; G06Q 30/0633; G01M 99/005; G06N 5/04

(57) ABSTRACT

Methods, computer program products, and systems are provided herein for providing predictive maintenance for an industrial cleaning device. An example method includes receiving operational data indicating operational parameters associated with the industrial cleaning device during operation thereof. The method further includes identifying a trend in the operational data. The method further includes determining that a particular fault event associated with the industrial cleaning device is likely to occur within a particular time frame. The method further includes providing an alert indicating that the particular fault event is likely to occur within the particular time frame.

### TECHNOLOGICAL FIELD

Embodiments of the present invention are generally related to methods, systems, computer program products, and apparatus for providing predictive maintenance and/or technical support for industrial cleaning devices.

### BACKGROUND

Industrial cleaning devices are important tools in various industries for maintaining compliance with hygiene protocols, providing a quality product, meeting customer cleanliness expectations, and/or the like. For example, industrial cleaning devices may be devices for cleaning floors; washers for trays, glassware, flatware, dishes, pots and pans, and/or the like (e.g., ware washers); commercial laundry machines; and/or the like. Thus, users and managers of an industrial cleaning device are not only concerned with keeping the industrial cleaning device operational, but also maintaining the quality of cleaning the industrial cleaning device achieves.

Therefore, there is a need in the art for methods, systems, computer program products, and apparatus for maintaining industrial cleaning devices such that the industrial cleaning device continues to consistently and efficiently clean well.

### SUMMARY

Various embodiments of the present invention provide methods, systems, computer program products, and apparatus for providing predictive maintenance for one or more industrial cleaning devices. For example, an industrial cleaning device may comprise one or more sensors configured to capture measurements of various parameters during operation of the industrial cleaning device. The captured measurements may be monitored to determine if measurements for one or more parameters are outside of an allowed range, follow a particular trend (e.g., a known trend, a trend under investigation, and/or the like), are in a warning or alert range, are trending toward the edge of the allowed range or a warning or alert range, and/or the like and to provide a notification or alert thereof. In various embodiments, in addition to providing a notification or alert, a part may be automatically ordered, a supply may be automatically ordered, service personnel may be informed that a part or supply should be ordered, maintenance may be scheduled, information regarding a short term solution may be provided, training resources may be provided, and/or the like. In this manner, the quality of the clean provided by the industrial cleaning device may be maintained and down time of the cleaning device may be minimized.

According to one aspect of the present invention, a method for providing predictive maintenance for an industrial cleaning device is provided. In an example embodiment, the method comprises receiving operational data indicating operational parameters associated with the industrial cleaning device during operation thereof; and identifying a trend in the operational data. The method may further comprise determining that a particular fault event associated with the industrial cleaning device is likely to occur within a particular time frame; and providing an alert indicating that the particular fault event is likely to occur within the particular time frame.

According to another aspect of the present invention, a system is provided. In an example embodiment, the system comprises at least one computer-readable storage medium storing computer-readable program code portions therein, at least one processor, and at least one communications interface. The system is in communication with at least one industrial cleaning device via the communications interface. The industrial cleaning device comprises operational sensors configured to capture operational data. The computer-readable program code portions are configured to, when executed by the at least one processor, cause the system to at least receive operational data indicating operational parameters associated with the industrial cleaning device during operation thereof; identify a trend in the operational data; determine that a particular fault event associated with the industrial cleaning device is likely to occur within a particular time frame; and provide an alert indicating that the particular fault event is likely to occur within the particular time frame.

According to still another aspect of the present invention, a computer program product is provided. In an example embodiment, the computer program product comprises at least one non-transitory computer-readable storage medium having computer-readable program code portions stored therein. The computer-readable program code portions are configured to, when executed by at least one processor, cause the processor to at least receive operational data indicating operational parameters associated with the industrial cleaning device during operation thereof; identify a trend in the operational data; determine that a particular fault event associated with the industrial cleaning device is likely to occur within a particular time frame; and provide an alert indicating that the particular fault event is likely to occur within the particular time frame.

According to yet another embodiment of the present invention, a method for providing predictive maintenance for an industrial cleaning device is provided. In example embodiments, the method comprises receiving operational data indicating operational parameters associated with the industrial cleaning device during operation thereof; detecting an anomaly in the operational data; determining if the anomaly is associated with a known trend; and flagging at least a portion of the operational data as including an anomaly.

According to another aspect of the present invention, a system is provided. In example embodiments, the system comprises at least one computer-readable storage medium storing computer-readable program code portions therein, at least one processor, and at least one communications interface. The system is in communication with at least one industrial cleaning device via the communications interface. The industrial cleaning device comprises operational sensors configured to capture operational data. The computer-readable program code portions are configured to, when executed by the at least one processor, cause the system to at least receive operational data indicating operational parameters associated with the industrial cleaning device during operation thereof; detect an anomaly in the operational data; determine if the anomaly is associated with a known trend; and flag at least a portion of the operational data as including an anomaly.

According to still another aspect of the present invention, a computer program product is provided. In an example embodiment, the computer program product comprises at least one non-transitory computer-readable storage medium having computer-readable program code portions stored therein. The computer-readable program code portions are configured to, when executed by at least one processor, cause the processor to at least receive operational data indicating operational parameters associated with the industrial cleaning device during operation thereof; detect an anomaly in the operational data; determine if the anomaly is associated with a known trend; and flag at least a portion of the operational data as including an anomaly.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention;

FIG. 2 is a block diagram of an industrial cleaning device, in accordance with various embodiments of the present invention;

FIGS. 3 and 6 provide flowcharts of various processes and procedures for providing predictive maintenance for an industrial cleaning device, in accordance with various embodiments of the present invention;

FIGS. 4 and 5 show example views of a user dashboard in accordance with various embodiments of the present invention;

FIGS. 7A, 7B, 7C, and 7D illustrate an example of identifying an anomaly in the operational data and determining that the anomaly is due to external factors, in accordance with an embodiment of the present invention;

FIGS. 8A and 8B provide graphs illustrating a flowrate through a dispensing unit that is identified as corresponding to a known trend, in accordance with an embodiment of the present invention; and

FIG. 9 is an exemplary schematic diagram of an analysis system according to various embodiments of the present invention.

### DETAILED DESCRIPTION OF VARIOUS EMBODIMENTS

Various embodiments of the present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

### I. General Overview

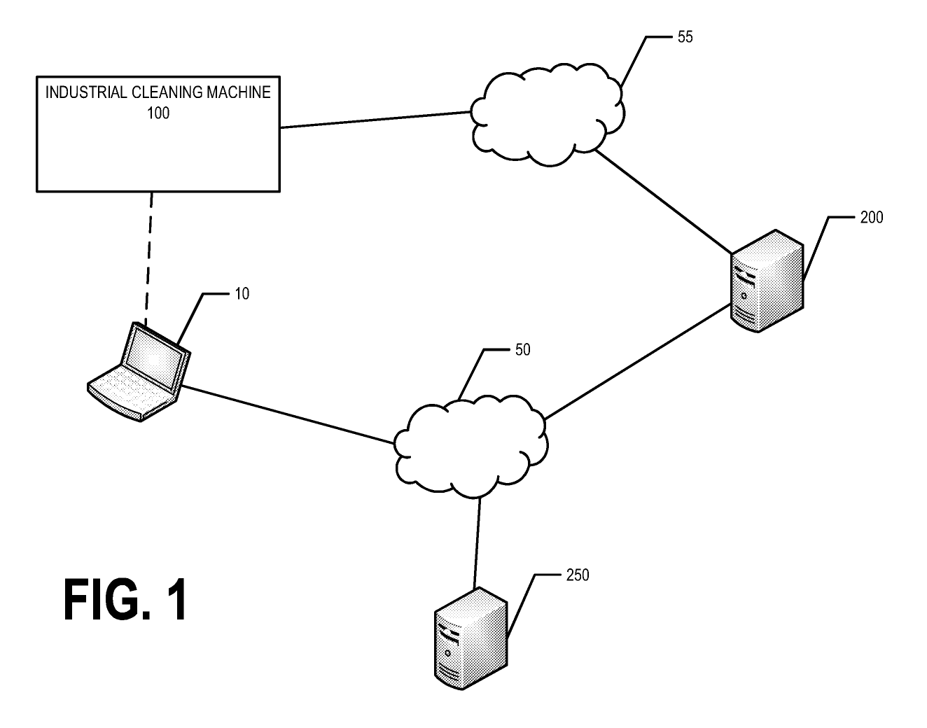

Various embodiments of the present invention are directed to providing predictive maintenance for an industrial cleaning device. In various embodiments, an industrial cleaning device may be a device for cleaning floors; washers for trays, glassware, flatware, dishes, pots and pans, and/or the like (e.g., ware washers); commercial laundry machines; and/or the like. The industrial cleaning device may comprise one or more sensors configured for capturing measurements of one or more operational parameters during operation of the industrial cleaning device. The captured measurements may be monitored by a local or remote computing system (e.g., an analysis system) to determine if one or more measurement values is outside of an allowed range, follows a particular trend (e.g., a known trend, a trend under investigation, and/or the like), is in a warning or alert range, is trending toward the edge of the allowed range or a warning or alert range, and/or the like and to provide an alert or notification thereof to a user or manager of the industrial cleaning device. In various embodiments, a warning range may be a range of measured values for a particular operational parameter in response to a detection of which a warning may be issued to warn a user or a manager of an industrial cleaning device 100 (see FIG. 1) that maintenance will likely need to be performed at some point in the foreseeable future. In various embodiments, an alert range may be a range of measured values for a particular operational parameter in response to a detection of which may cause an alert to be issued to indicate to a user or manager of an industrial cleaning device 100 that an action should be or is being taken (e.g., the ordering of a part or supply, scheduling of a maintenance visit, a short term solution should be used, training resources should be utilized). In addition to providing notification, the computing system may be configured to automatically order a part, automatically order a supply (e.g., cleaning chemical refill), schedule maintenance, provide information regarding a short term solution, provide training resources, and/or the like.

FIG. 1 illustrates an example embodiment of a system that may implement the present invention. In this particular embodiment, the illustrated system may include one or more industrial cleaning devices 100, one or more analysis systems 200, one or more supplier systems 250, and one or more user computing entities 10. The one or more industrial cleaning devices 100, the one or more analysis systems 200, the one or more supplier systems 250, and the one or more user computing entities 10 may communicate with each other and/or a variety of other computing entities via one or more wired or wireless networks, such as networks 50, 55. In one embodiment, the industrial cleaning device 100 may communicate operational data/information to a user computing entity 10 via a wired or short range wireless connection (e.g., Bluetooth), as shown by the dashed line in FIG. 1. The user computing entity 10 may then communicate the operational data/information to the analysis system 200 via wired or wireless network 50. In another embodiment, the industrial cleaning device 100 may communicate with the analysis system 200 via wired or wireless network 55 (e.g., a 3G network, the Internet).

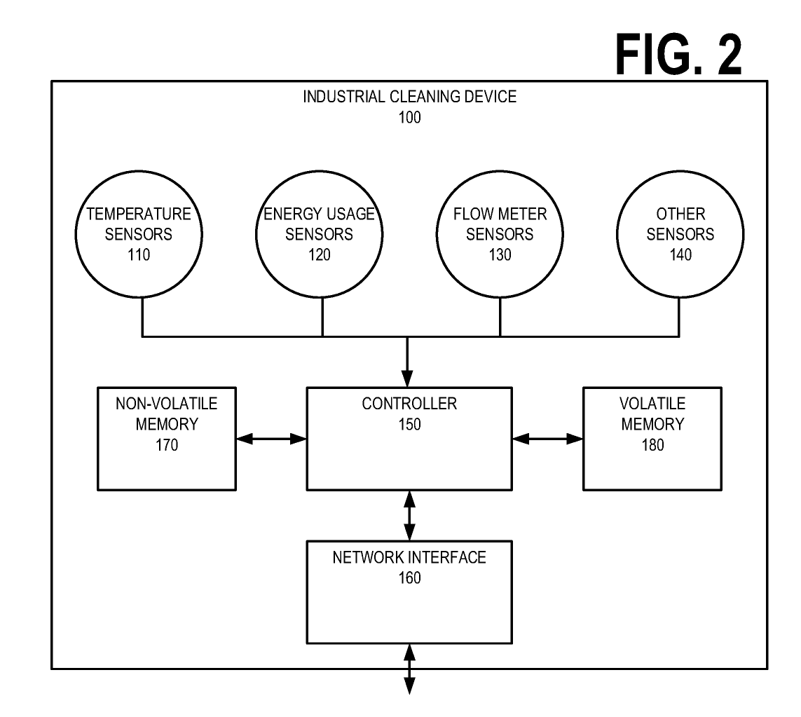

In various embodiments, the industrial cleaning device 100 may comprise one or more sensors (e.g., temperature sensors 110, energy use sensors 120, water flow meter sensors 130, other sensors 140), as shown in FIG. 2. The sensors may capture measurements of operational parameters. The operational parameters may be provided, transmitted, and/or communicated to the analysis system 200 (e.g., via network interface 160). The analysis system 200 may then monitor the captured measurements of the operational parameters and provide an alert and/or notification if one or more measurement values is outside of an allowed range, follows a particular trend (e.g., a known trend, a trend under investigation, and/or the like), is in a warning or alert range, is trending toward the edge of the allowed range or a warning or alert range, and/or the like and to provide an alert or notification thereof to a user or manager of the industrial cleaning device. For example, the analysis system 200 may provide an alert and/or notification to a user computing system 10 (e.g., user terminal, user mobile phone, an email address for a user, etc.). In addition to providing notification, the computing system may be configured to automatically order a part or a supply (e.g., by contacting supplier system 250), schedule maintenance, provide information regarding a short term solution, provide training resources, and/or the like.

Various embodiments of the present invention will now be described with more detail.

### II. Exemplary System Operation

In various embodiments, the industrial cleaning device 100 is configured to capture measurements of operational parameters during operation of the industrial cleaning device 100. The operational parameters may comprise a prewash temperature, wash temperature, rinse temperature, drying temperature, electricity usage, water usage, water flow through various portions of the industrial cleaning device 100 (e.g., through a cleaning chemical dispenser, through a water input valve, through a drain valve, and/or the like), chemical/product usage (e.g., amount of detergent or other cleaning chemicals dispensed/used during operation), chemical/product concentration (e.g., concentration of detergent or other cleaning chemicals in prewash fluid, wash fluid, rinse fluid, and/or the like), and/or other operational parameters. The industrial cleaning device 100 is configured to provide operational data/information comprising at least a portion of the captured measurements of operational parameters to the analysis system 200. In some embodiments, industrial cleaning device 100 may provide the operational data/information to the analysis system 200 via the user computing entity 10. In various embodiments, the operational data/information is provided to the analysis system 200 in real time (or near real time), after completion of each operation of the industrial cleaning device, daily, weekly, upon detection of an error by the industrial cleaning device (e.g., a low water supply alert, and/or the like), and/or the like. In addition to one or more captured measurements of operational parameters, the operational data/information may comprise a device identifier configured to uniquely identify the industrial cleaning device 100, a location associated with the industrial cleaning device, a time stamp, and/or contextual data/information associated with the operational parameters.

The analysis system 200 may be configured to analyze, process, and/or store at least a portion of the operational data/information. If it is determined that one or more measurement values is outside of an allowed range or preferred trend, follows a particular trend (e.g., a known trend, a trend under investigation, and/or the like), is in a warning or alert range, is trending toward the edge of the allowed range or a warning or alert range, and/or the like and to provide an alert or notification thereof to be displayed via the user computing entity 10. For example, the analysis system 200 may provide an alert to the user computing entity 10, that, when executed and/or processed by the user computing entity 10, causes a notification to be displayed or provided (e.g., an audible notification) by a user interface of the user computing entity 10. In addition to providing notification, the analysis system 200 may be configured to automatically order a part or a supply (e.g., by contacting supplier system 250), schedule maintenance, provide information regarding a short term solution, provide training resources, and/or the like.

In various embodiments, the operational data/information may be used for various purposes. For example, resource utilization (e.g., water usage, energy usage) and consumable efficiency (e.g., cleaning chemical usage, dispenser usage and maintenance, remote dispenser usage and maintenance) may be monitored. Targeted trainings and/or consultations may be provided based on the operational data/information and/or analysis thereof. Additionally, monitoring of the operational data/information may assist customers in maintaining hygiene compliance by providing training for users of the industrial cleaning device 10 (including providing corrective feedback), triggering the occurrence of maintenance of an industrial cleaning device and/or portion thereof (e.g., a cleaning chemical dispenser providing cleaning chemicals to the industrial cleaning device), monitoring energy and/or water usage, monitoring cleaning chemical usage to ensure the used chemical concentration is within an allowed range, and/or providing targeted technical service. Thus, the monitoring of operational data/information and the provision of predictive maintenance based on analysis of the operational data/information may provide a customer with an array of advantages.

### 1. Detecting a Known Trend

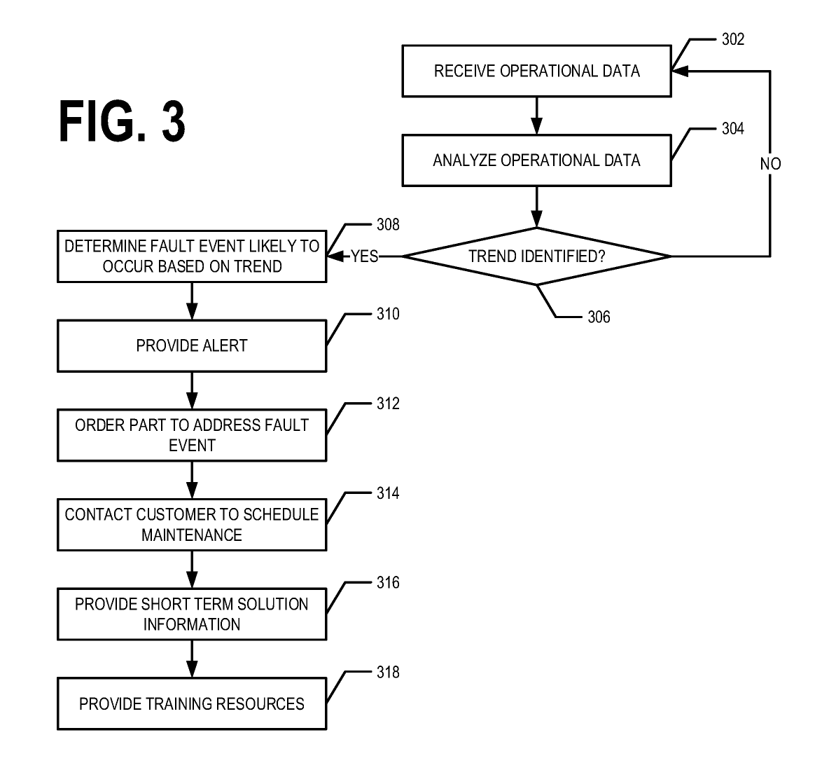

FIG. 3 provides a flowchart illustrating various processes and procedures that may be completed as part of providing predictive maintenance for one or more industrial cleaning devices 100. Starting at step 302, new operational data/information is received. For example, the analysis system 200 may receive new operational data/information from one or more industrial cleaning devices 100. In various embodiments, the new operational data/information may be stored by analysis system 200. For example, the analysis system 200 may store more than a year's worth, up to a year's worth, a quarter's worth, a month's worth, a week's worth and/or some other time frame's worth of operational data/information for at least one industrial cleaning device 100.

At step 304, the data is analyzed. For example, the analysis system 200 may analyze at least a portion of the operational data/information. For example, it may be determined if one or more measured values of the new operational data/information is outside of an allowed or preferred range, is within a warning or alert range, and/or the like. The new operational data/information may be combined with stored operational data/information to calculate/determine the average measured value for an operational parameter for the past n uses of the industrial cleaning device (e.g., the last 10 times the operational cleaning device was run), for the past week day, the past 24 hours, the past week, the past 7 days, the past month, the past 30 days, and/or the like. In some embodiments, it may be determined if the average measured value is outside of an allowed or preferred range, is within a warning or alert range, and/or the like. In various embodiments, the new operational data/information is combined with stored operational data/information to determine if any trends are present in the operational data/information. For example, the operational data/information may follow a preferred trend (e.g., a consistent and allowed measured value of a particular parameter), a known trend, and/or some other trend. In various embodiments, a known trend is a trend that has been identified as indicating a particular fault event is likely to occur within a particular time frame. For example, a known trend may indicate an impending failure of a particular portion of the industrial cleaning device within a qualified time frame (e.g., a week, a month, a couple months, a year). In some embodiments, if some other trend is identified in the operational data (e.g., a trend that is not known or not yet known to be associated with a particular fault event and/or particular time frame), the trend may be monitored to determine if the trend appears to be correlated with a future failure of at least a portion of the industrial cleaning device 100 or a fault event associated therewith. In various embodiments, the operational data/information is analyzed each time new operational data/information is received (e.g., in real time or near real time), once a day, once a week, and/or the like. For example, analysis of the operational data/information may be performed periodically and/or may be triggered by a particular measured value being outside of an allowed range (e.g., greater than or less than a threshold value), and/or the like.

At step 306, it is determined if a known trend was identified or detected in the operational data/information. For example, the analysis system 200 may determine if a known trend was identified or detected in the operational data/information. If a known trend was not identified or detected in the operational data/information, the analysis system 200 may wait to receive additional operational data/information to analyze. If a known trend is identified or detected in the operational data/information for the industrial cleaning device 100, the process continues to step 308.

At step 308, a fault event that is likely to occur for the industrial cleaning device 100 and a time frame in which the fault event is likely to occur may be identified and/or determined. For example, the analysis system may identify and/or determine a fault event that is likely to occur for the industrial cleaning device 100 and a time frame in which the fault event is likely to occur. The identified and/or determined fault event and associated time frame may be identified and/or determined based at least in part on the trend identified in the operational data/information and/or previously observed trends and/or a trend template. For example, if previously for a particular industrial cleaning device 100, a particular trend has been identified a week before a fault event occurs, it may be determined that that same fault event is likely to occur in approximately a week if the trend is again identified in the operational data/information for the industrial cleaning device 100. For example, if the amount of cleaning chemical (e.g., detergent or cleaning product) within a reservoir of cleaning product (or an amount of chemical used) is following a particular trend, this may indicate that the cleaning chemical will need to be refilled in approximately one week. In another example, a trend template may be based on previous operational data/information for one or more industrial cleaning devices 100. The observed trend may be compared to the trend template to determine a time frame for which the fault event is likely to occur. For example, the flow of water through a chemical dispenser may be gradually decreasing. The trend template associated with this trend may indicate that if the flow of water through the chemical dispenser reaches a particular value, has a particular rate of decrease, and/or the like, then the quality of cleaning provided by the industrial cleaning device 100 will fall below a threshold level in approximately a month. Thus, based on the identified trend, a fault event and an associated time frame may be identified and/or determined.

At step 310, an alert or notification may be provided. For example, an alert or notification may be generated by the analysis system 200 and provided, transmitted, and/or communicated to the user computing entity 10 such that the user computing entity 10 may display the alert or notification to the user or manager of the industrial cleaning device 100. For example, the analysis system 200 may provide an alert to the user computing entity 10, that, when executed and/or processed by the user computing entity 10, causes a notification to be displayed or provided (e.g., an audible notification) by a user interface of the user computing entity 10. For example, each industrial cleaning device 100 may be associated with a device identifier configured to uniquely identify the industrial cleaning device 100. Each device identifier may be stored in association with a customer profile. The customer profile may include one or more locations at which monitored industrial cleaning devices are installed, contact information for one or more managers of an industrial cleaning device, and/or other information. The contact information may be used to identify an email address to which an email notification may be sent, an IP or other electronic address of a user computing entity 10 associated with the industrial cleaning device 100 to which an alert may be sent, and/or a profile to which an alert may be posted.

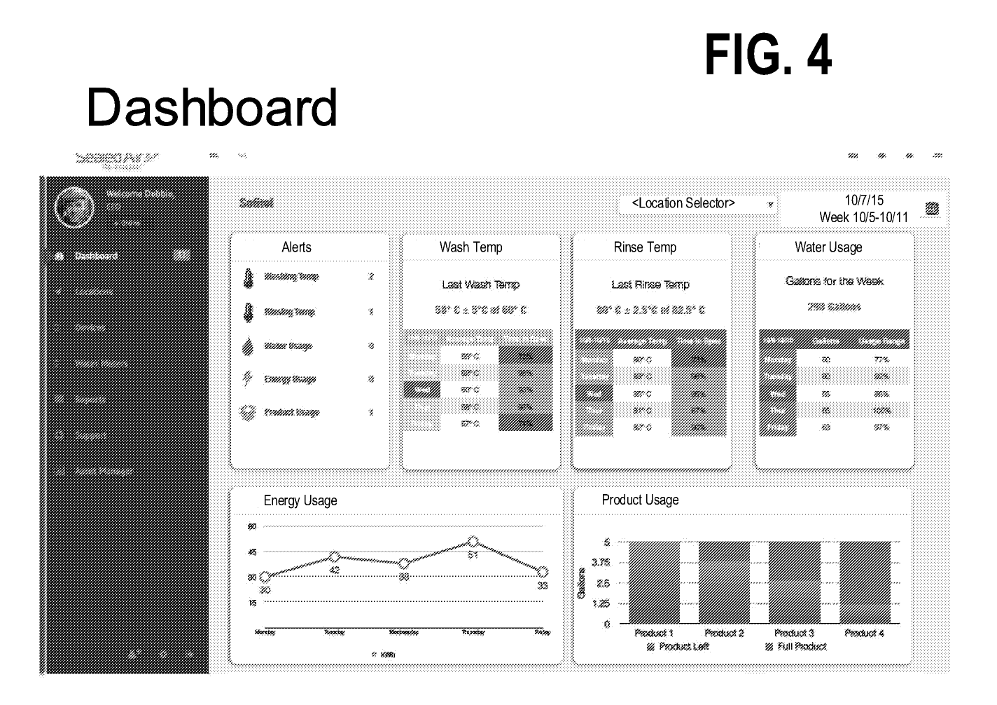

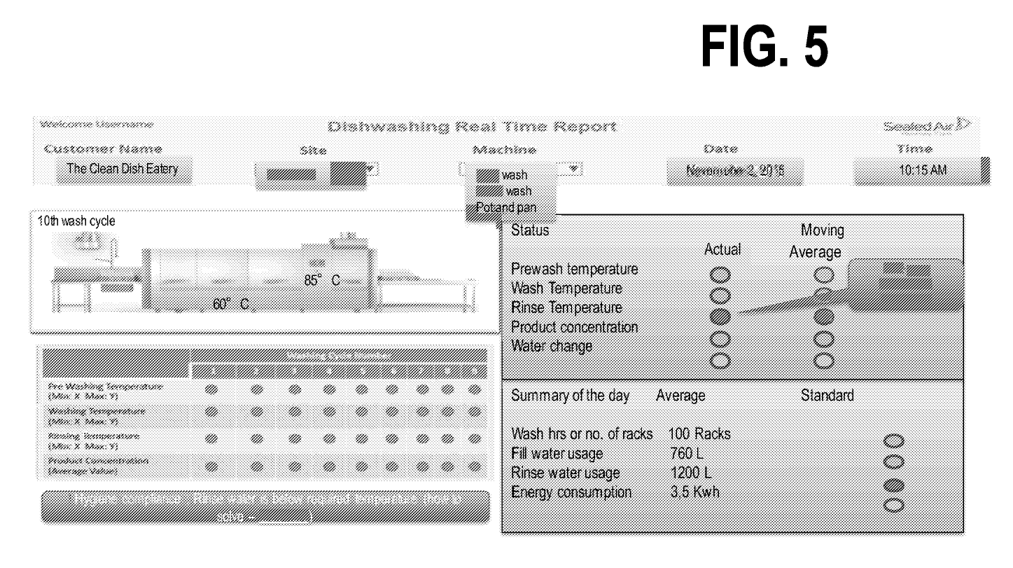

In various examples, the analysis system 200 may be configured to provide a dashboard (e.g., an interactive graphical user interface) that may be used by a user or manager of an industrial cleaning device to view at least some operational data/information, receive alerts, and/or the like. For example, the user may view and/or interact with the dashboard interface via the user computing entity 10. For example, the user may log on to a website associated with the operator of the analysis system 200 to access the dashboard. In other embodiments, the dashboard may be provided via an application stored on the user computing entity 10 (e.g., an Internet browser or dedicated application). FIGS. 4 and 5 provide example views of a dashboard in accordance with various embodiments of the present invention. For example, the dashboard may provide the user or manager of the industrial cleaning device 100 (e.g., operating the user computing entity 10) with one or more alerts, measurement values for one or more operational parameters, an indication of whether one or more measurement values of one or more operational parameters (or a running average thereof) are within an allowed range or trend for a particular time period, information regarding water usage, product usage, and/or energy usage by the industrial cleaning device, and/or the like. Thus, in various embodiments, the analysis system 200 may provide an alert via the dashboard or other electronic address (e.g., an email sent to an email address, a short message service (SMS) or multimedia message service (MMS) message sent to a telephone number, and/or the like).

Returning to FIG. 3, at step 312, a part or supply for the industrial cleaning device 100 may be ordered. For example, the analysis system 200 may contact a supplier system 250 and order a part and/or supply (e.g., a cleaning chemical refill) for the industrial cleaning device 100. For example, if the identified fault event is that the industrial cleaning device will use up the available reservoir of a particular cleaning chemical in approximately a week, a refill of the particular cleaning chemical may be ordered such that the refill is delivered to the location of the industrial cleaning device 100 before the expiration of a week. In another example, if the identified trend shows that the amount of water through a cleaning chemical dispenser is decreasing, indicating that a particular seal may not be functioning properly, a new seal may be ordered. Thus, the part or supply ordered is based on the known trend identified and/or the fault event corresponding to the known trend. The part or supply may be ordered such that the part of supply is expected to reach the location of the industrial cleaning device 100, or to the office of a technician who will perform the maintenance, prior to the expiration of the time frame within which the fault event is likely to occur. In one embodiment, a service personnel (e.g., a technician or other associate of the organization or company operating the analysis system 200) or user or manager of the industrial cleaning device 100 may be prompted to order (e.g., via an electronic notification) a particular part or supply for the industrial cleaning device 100.

Continuing to step 314, the customer may be contacted to schedule a maintenance. For example, the analysis system 200 may contact the customer (e.g., via the dashboard, email, voice message, or other means) to schedule a maintenance. In another embodiment, the analysis system 200 may prompt an employee of the operator of the analysis system 200 to call the customer to schedule a maintenance. For example, if prevention of the fault event that is likely to occur requires a skilled technician, a maintenance may be scheduled. For example, the maintenance may be scheduled within and/or before the expiration of the time frame within which the fault event is likely to occur. In various embodiments, if a regular maintenance is due in the near future and/or within the time frame, the regular maintenance may be scheduled (if it was not already scheduled) and/or addressing prevention of the identified fault event may be added to the agenda of the maintenance visit.

At step 316, information regarding a short term solution may be provided. For example, the analysis system 200 may provide information regarding a short term solution (e.g., via email, the dashboard, and/or the like) to a user or manager of the industrial cleaning device 100. For example, if the identified fault event is likely to cause the quality of cleaning provided by the industrial cleaning device 100 to fall below a threshold quality within a time frame, but a short term solution may maintain the quality of cleaning for an expanded time frame, information regarding a short term solution may be provided. A maintenance visit may then be scheduled to occur within and/or before the expiration of the expanded time frame. For example, if the flow of water through a dispenser appears to be decreasing at a particular rate or in a particular manner, a short term solution may be to clean an inline water filter of the industrial cleaning device 100. Thus, information regarding how to clean the inline water filter may be provided to a user or manager of the industrial cleaning device 100. Cleaning the inline water filter may delay the occurrence of the fault event and provide an expanded time frame during which maintenance may be scheduled (e.g., the expanded time frame may be a few weeks or a few months longer than the originally identified time frame).

At step 318, training resources may be provided. For example, the analysis system 200 may provide training resources pertaining to the identified fault event (e.g., via email, the dashboard, augmented reality, and/or the like). For example, if the fault event may be caused by user error, training resources directed to preventing a repeat of the user error may be provided. In another example, if the maintenance to prevent the fault event may be performed by a user of the industrial cleaning device 100, training resources may be provided regarding how to complete the maintenance to prevent the fault event. For example, if a cleaning chemical reservoir needs to be refilled or exchanged for a new cleaning chemical reservoir, instructions regarding how to refill or change out the cleaning chemical reservoir may be provided. In another example, training resources regarding routine maintenance that should be performed may be provided to a user or manager of the industrial cleaning device 100. For example, if the identified known trend indicates that the industrial cleaning device 100 needs to be descaled, training resources showing how to descale the industrial cleaning device 100 may be provided to a user or manager of the industrial cleaning device 100. For example, training resources may be provided via a virtual reality environment as described in more detail by International Application PCT/US2015/053980, which is incorporated in its entirety herein by reference.

In various embodiments, one or more of step 312, 314, 316, and/or 318 may be performed. For example, the analysis system 200 may order a new bottle of a cleaning chemical and provide instructions regarding how to remove the old bottle and provide the new bottle of cleaning chemical to the industrial cleaning device 100. In another example, a new inline water filter may be ordered, a maintenance may be scheduled for the installation of the new inline water filter, and information regarding a short term solution (e.g., cleaning the existing inline water filter) may be provided. Thus, in response to identifying a known trend within the operational data/information, the analysis system 200 may complete multiple tasks in order to prevent an identified fault event from occurring. Thus, task(s) completed by the analysis system 200 may be aimed at preventing the identified fault event from effecting the quality of cleaning provided by the industrial cleaning device 100, causing the industrial cleaning device to experience down time, and/or the like.

### 2. Detecting an Anomaly

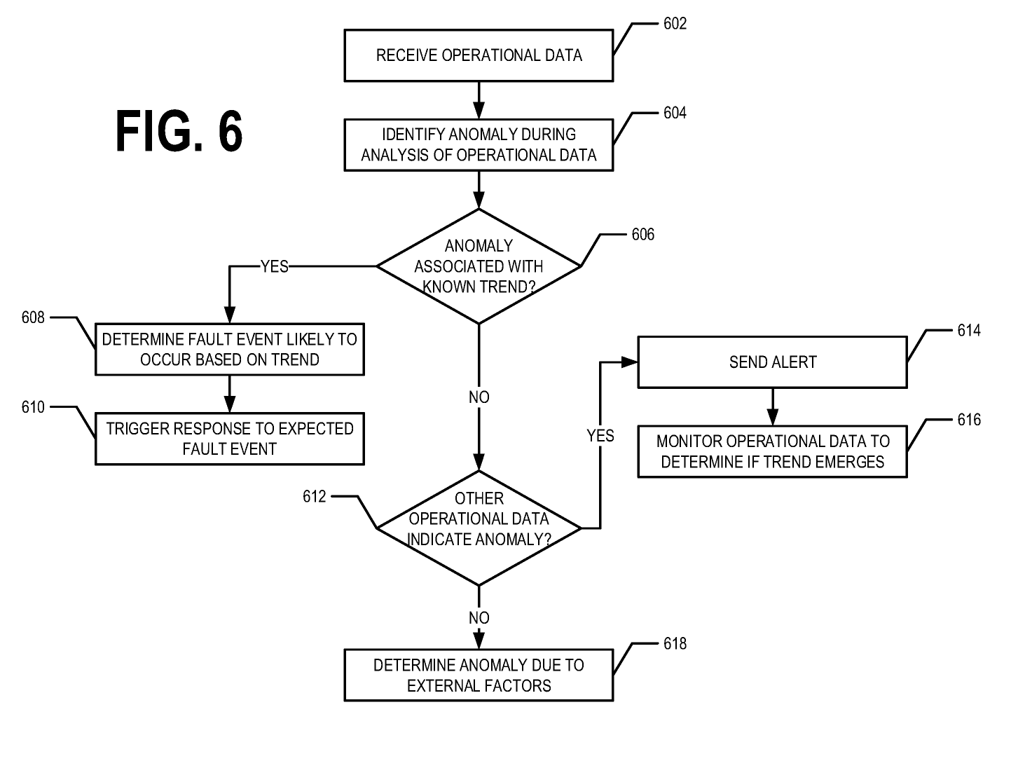

FIG. 6 provides a flowchart of various operations and procedures that may be completed in providing predictive maintenance of an industrial cleaning device 100. Starting at step 602, new operational data/information is received, similar to step 302. For example, the analysis system 200 may receive new operational data/information from one or more industrial cleaning devices 100. In various embodiments, the new operational data/information may be stored by analysis system 200. For example, the analysis system 200 may store more than a year's worth, up to a year's worth, a quarter's worth, a month's worth, a week's worth and/or some other time frame's worth of operational data/information for at least one industrial cleaning device 100.

At step 604, the data is analyzed and an anomaly is identified. For example, the analysis system 200 may analyze at least a portion of the operational data/information and identify an anomaly in the operational data/information. For example, it may be determined that one or more measured values of the new operational data/information (or stored operational data/information) is outside of an allowed or preferred range (e.g., greater than or less than a threshold value), is within a warning or alert range, and/or the like. The new operational data/information be combined with stored operational data/information to calculate/determine the average measured value for an operational parameter for the past uses of the industrial cleaning device (e.g., the last 5 or 10 times the operational cleaning device was run), for the past week day, the past 24 hours, the past week, the past 7 days, the past month, the past 30 days, and/or the like. In some embodiments, it may be determined that the average measured value is outside of an allowed or preferred range (e.g., greater than or less than a threshold value), is within a warning or alert range, and/or the like. In various embodiments, the new operational data/information is combined with stored operational data/information to detect and/or identify an anomaly trend in the operational data/information. For example, the operational data/information may be trending toward a threshold value. In various embodiments, the operational data/information is analyzed each time new operational data/information is received, once a day, once a week, and/or the like. For example, analysis of the operational data/information may be performed periodically and/or may be triggered by a particular measured value being outside of an allowed range (e.g., greater than or less than a threshold value), and/or the like.

At step 606, it is determined if the identified or detected anomaly is associated with a known trend. For example, the analysis system 200 may determine if the anomaly is associated with a known trend. In various embodiments, a known trend is a trend that has been identified as indicating a particular fault event is likely to occur within a particular time frame. For example, the analysis system 200 may store trend information/data such as a trend template. The identified or detected anomaly (and/or operational data/information associated/corresponding therewith) may be compared to the trend template to determine if the identified or detected anomaly is associated a known trend. If at step 606, it is determined that the identified or detected anomaly is associated with a known trend, the process continues to step 608. At step 608, a fault event that is likely to occur with respect to the industrial cleaning device 100 is determined based on the known trend associated with the detected or identified anomaly. A time frame within which the fault event is likely to occur may also be determined. For example, the analysis system 200 may determine a fault event that is likely to affect the cleaning quality of the industrial cleaning device and a time frame within which the fault event is likely to occur, based at least in part on the identified or detected anomaly and/or the known trend associated therewith. For example, a fault event and a time frame within which the fault event may occur may be determined similar as described above.

At step 610, a response to the expected fault event is triggered. For example, the analysis system 200 may trigger one or more actions based at least in part on the expected fault event and the time frame within which the fault event is likely to occur. For example, an alert or notification may be generated and transmitted, a part or supply may be ordered, maintenance may be scheduled, information regarding a short term solution may be provided, training resources may be provided, and/or the like. For example, an alert or notification may be provided to a user or manager of the industrial cleaning device 100 in response to determining the fault event and the time frame within which the fault event is likely to occur. In various embodiments, an alert or notification may be provided by email, a dashboard displayed via the user computing entity 10, SMS or MMS message, and/or the like. In another example, a part or supply (e.g., cleaning chemicals) may be ordered in response to determining the fault event and the time frame within which the fault event is likely to occur. For example, based on the determined fault event, the analysis system 200 may identify a part or supply to address the fault event that is likely to occur and communicate with a supplier system 250 to order the part or supply. In various embodiments, the part or supply may be ordered with an expected delivery date before the expiration of the time frame in which the fault event is likely to occur. In another example, a maintenance visit by a technician may be scheduled. For example, maintenance may be scheduled via a telephone conversation, in response to an email sent to a user or manager of the industrial cleaning device 100, through the dashboard (e.g., in response to a notification that a maintenance should be scheduled), and/or the like. For example, a technician may be scheduled to come to the location of the industrial cleaning device 100 and perform maintenance on the industrial cleaning device 100 and/or a cleaning solution dispenser associated with the industrial cleaning device 100 to prevent the occurrence of the fault event. In various embodiments, the maintenance may be scheduled to take place before the expiration of the time frame within which the fault event is likely to occur. In another example, information regarding a short term solution may be provided to a user or manager of an industrial cleaning device 100 via email, a dashboard (e.g., displayed via a user computing entity 10), and/or the like. For example, a short term solution may be a solution that will not indefinitely prevent the fault event but may cause the cleaning quality of the industrial cleaning device to remain at an allowed level for a longer time period, thereby extending the time frame within which the fault event is likely to occur and giving an expanded time frame within which maintenance may be scheduled. In another example, training resources may be provided to a user or manager of the industrial cleaning device 100. For example, training resources regarding how to refill the cleaning chemicals, corrective training (e.g., to prevent reoccurrence of a user error), instructions regarding how to perform low skill or regular maintenance (e.g., maintenance that need not be completed by a trained technician) that may prevent or prolong the occurrence of a fault event, and/or the like may be provided. For example, training resources related to descaling the industrial cleaning machine 100, cleaning an inline water filter, replacing/refilling a cleaning chemical, and/or the like may be provided. For example, the training resources may be provided via email, a dashboard (e.g., displayed via the user computing entity 10), through augmented reality, and/or the like. Thus one or more of a variety of actions may be taken to address and/or prevent the fault event within the time frame that the fault event is likely to occur.

If at step 606 it is determined that the anomaly is not associated with a known trend, the process continues to step 612. At step 612, it is determined if other operational data/information indicates an anomaly in the operation of the industrial cleaning device 100. For example, the analysis system 200 may determine if other operational data/information indicates an anomaly. For example, a measurement of the conductivity of the wash fluid, which may be used to monitor the concentration of cleaning chemicals in the wash fluid, may indicate a spike on a particular day or during a particular operation of the industrial cleaning device 100. Another measured value may indicate how much cleaning chemical is dispensed each time the industrial cleaning device 100 was operated. If a measured value of the conductivity of the wash fluid indicates an anomaly, the one or more corresponding measured values (e.g., the measured values for the same operation of the industrial cleaning device 100, and/or having a time stamp associated therewith that is similar to the time stamp associated with the anomalous data) indicating how much cleaning chemical was dispensed may be checked to see if the corresponding measured values also indicate an anomaly. If the corresponding measured values do not indicate an anomaly, the process continues to step 618. At step 618, it is determined that the anomaly was due to external factors. For example, the analysis system 200 may determine that the anomaly was due to external factors. For example, the conductivity of the wash fluid may have been increased by salt entering the wash fluid from a set of particularly salty dishes being washed. If the anomaly is due to external factors, the anomaly does not indicate that a fault condition is likely to occur and no immediate action may be required. In various embodiments, if an anomaly is detected, the corresponding operational data/information may be displayed to service personnel for a manual analysis of whether the anomaly is due to external factors.

If at step 612 it is determined that the corresponding operational data/information and/or other operational data/information from the industrial cleaning device is also exhibiting an anomaly, the process continues to step 614. Continuing the example from above, if the measured values indicating the amount of cleaning chemical dispensed indicates that an abnormal amount of cleaning chemical was dispensed, the process may continue to step 614. At step 614, an alert or notification may be sent to a user or manager of an industrial cleaning device 100 and/or to a technician or group of technicians that provide technical support and/or maintenance for the industrial cleaning device. For example, the analysis system 200 may send an alert or notification regarding the anomalous operational data/information to a user or manager of the industrial cleaning device 100 or a technician or group of technicians that provide technical support and/or maintenance for the industrial cleaning device. For example, a user or manager of the industrial cleaning device 100 may receive an email alert or notification, be provided with an alert or notification via a dashboard (e.g., displayed via the user computing entity 10), and/or the like. For example, the analysis system 200 may provide an alert to the user computing entity 10. Responsive to the user computing entity 10 executing and/or processing the alert, a dashboard may be activated to be displayed and/or provided through a user interface of the user computing entity 10 and the notification of the alert may be provided therethrough. For example, the alert or notification may indicate that an anomaly has been detected, may provide one or more training resources aimed at preventing such an anomaly that may be caused by human error, may prompt the user or manager to schedule a maintenance visit so that a technician may investigate the anomaly, and/or the like.

At step 616, the operational data/information for the particular industrial cleaning device 100 may be flagged to indicate that an anomaly has been detected therein and monitored to determine if a trend associated with the anomaly emerges, is detected, or is identified. For example, the analysis system 200 may flag the operational data/information comprising the anomaly and monitor the operational data/information for the industrial cleaning device 100 to determine if a trend associated with the anomaly emerges, is detected, or is identified. For example, the operational data/information for the industrial cleaning device 100 may be monitored to determine if a fault event occurs and what time frame the fault event occurs within to determine if the anomaly was indicative of the subsequent fault event. In this manner, new known trends may be identified to provide improved predictive maintenance for the industrial cleaning device 100 over time.

### 3. Example 1

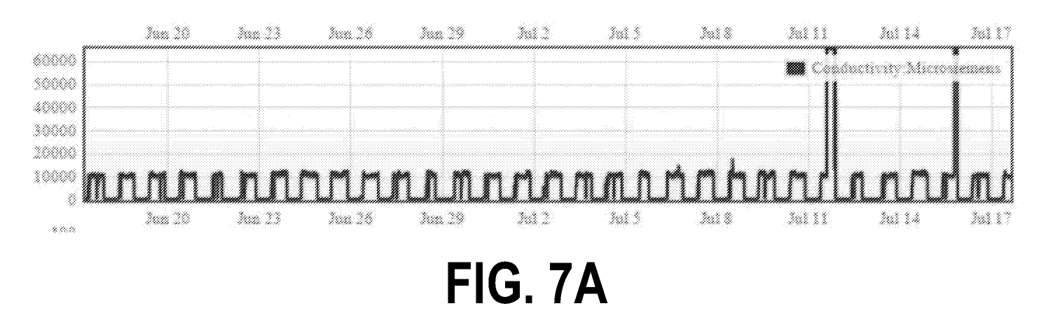

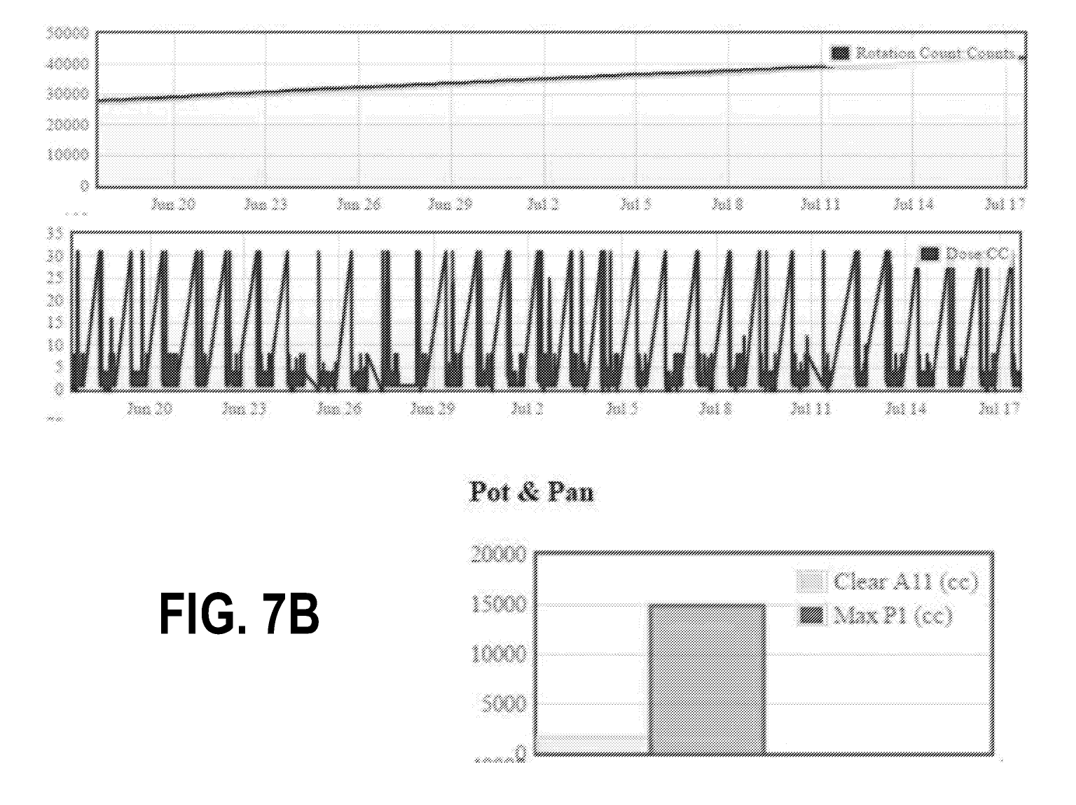

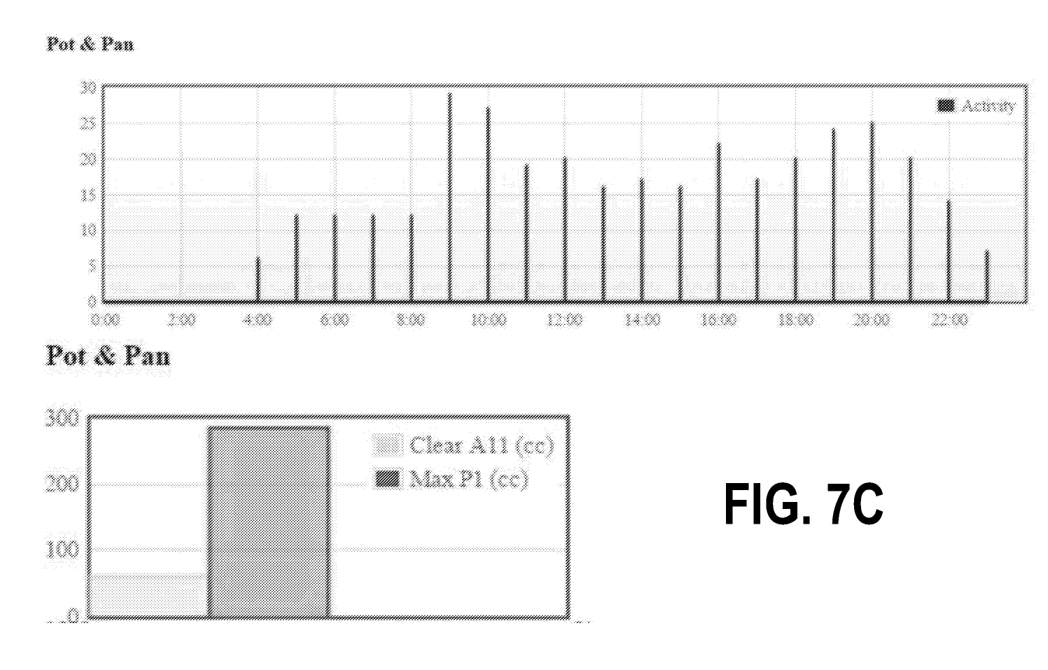

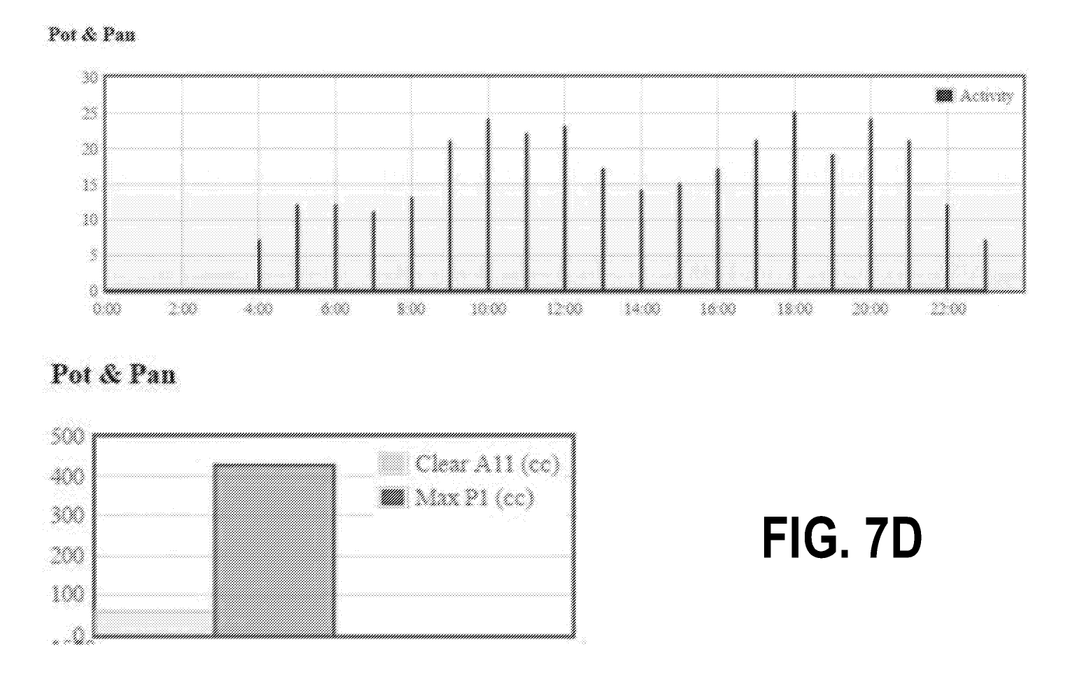

FIGS. 7A, 7B, 7C, and 7D illustrate portions of operational data/information in which an anomaly is detected/identified in the operational data/information and it is determined that the anomaly is due to external factors. FIG. 7A provides a chart showing the measured conductivity of the wash fluid of an industrial cleaning device 100 for the 30 day period of June 17^{th} through July 17^{th}. The conductivity of the wash fluid may be used to indicate the concentration of cleaning chemicals in the wash fluid in various embodiments. The analysis system 200 may identify/detect a spike in the conductivity of the wash fluid on July 11^{th} and July 15^{th}. The identified/detected anomaly is not associated with a known trend, so the analysis system 200 analyzes operational data/information corresponding to the identified/detected anomaly (the spike in conductivity of the wash fluid on July 11^{th} and July 15^{th}) to determine if the corresponding operational data/information also exhibits an anomaly.

FIG. 7B provides three charts showing operational data/information related to the amount of cleaning chemical dispensed during the 30 day period of June 17^{th} through July 17^{th}. The rotation count counts (the number of times a dispensing mechanism within the cleaning chemical dispenser has rotated to cause cleaning chemical to be dispensed), the cleaning chemical dose, and the overall amount of cleaning chemicals used during the 30 day period are shown. The corresponding operational data/information shows that approximately 0.5 kg of cleaning chemical were used each day during the 30 day period being considered.

FIGS. 7C and 7D provide graphs showing the activity and cleaning chemical used on July 11^{th} and July 15^{th}, respectively. The activity on July 11^{th} and July 15^{th} follow a preferred trend (e.g., are consistent with normal operation expectations). The cleaning chemical usage on July 11^{th} and July 15^{th} was actually slight less than the average daily cleaning chemical usage of 0.5 kg. Thus, as seen from FIGS. 7B, 7C, and 7D, the corresponding operational data/information does not indicate any further anomalies. Therefore, it is determined that the anomalous spike the wash fluid conductivity was due to an external factor. For example, the pots and pans may not have been properly pre-rinsed before being put into the industrial cleaning device 100, causing salt from the pots and pans to be dissolved into the wash fluid, thereby increasing the conductivity of the wash fluid. In one embodiment, no further action is taken. In another embodiment, a notification/reminder and/or training resources related to pre-rinsing pots and pans is provided to a user or manager of the industrial cleaning device 100 (e.g., via the user computing entity 10).

### 4. Example 2

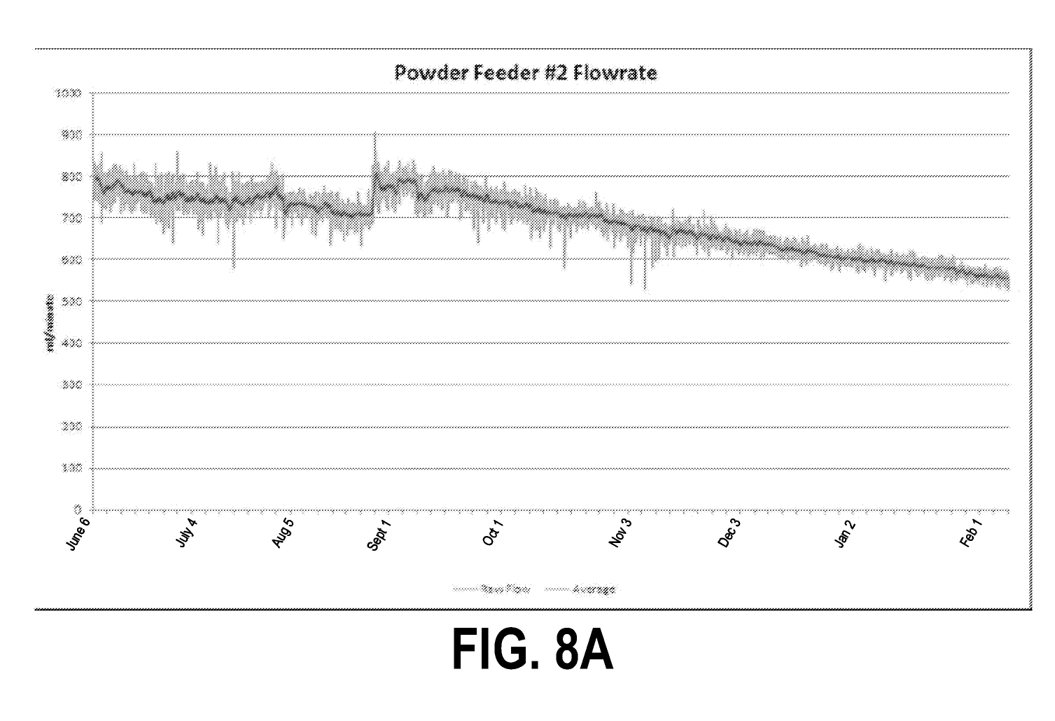

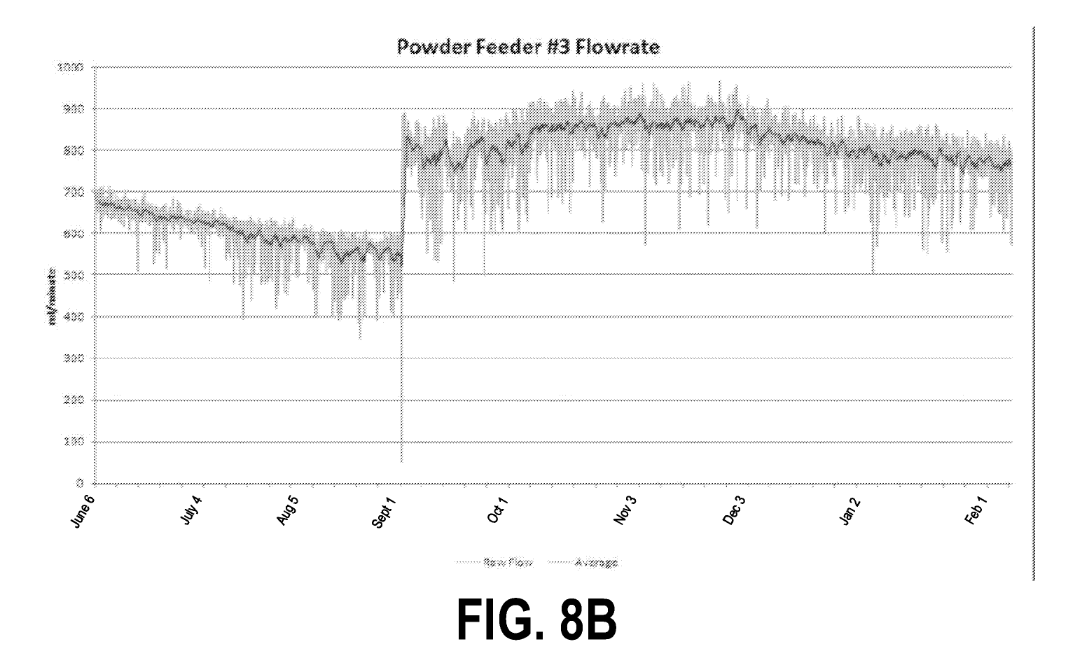

FIGS. 8A and 8B provide graphs showing the flow rate through two different cleaning chemical dispenser units. The left portion of each of the graphs shows a decrease in the flow rate through the corresponding dispenser unit, indicating that the dispenser unit needs to be replaced and that, if not replaced, the dispenser unit will cause the industrial cleaning device 100 to experience a fault event (e.g., failure of the dispenser unit which may lead to ‘no water’ alarms, ‘blocked channel’ alarms, build-up of cleaning chemicals in the dispenser unit, reduced quality of clean, and/or the like). For this particular known trend, a short term solution is known. For example, if the water pressure of the water supplied to the dispenser unit is increased (e.g., from 25 PSI to 40 PSI), the dispenser unit may continue to operate effectively for an expanded time frame. For example, in both FIGS. 8A and 8B, a step up in the flow through the dispensing unit can be seen when the short term solution is applied. After the short term solution is applied, the flow through the dispensing unit again begins to slowly decline. However, by applying the short term solution, an expanded time frame in which the maintenance may be scheduled to prevent the fault event from occurring is provided. The maintenance may be scheduled and the impending fault event may be prevented.

Additionally, however, the steady decline in flow rate shown in FIGS. 8A and 8B may be determined to indicate a trend. For example, in the future, if a similar decrease in flow rate is determined from received operational data, it can be predicted that a failure or fault will occur at or around a certain time. This information can be used to predict the failure or fault. In this regard, some embodiments of the present invention can be configured to identify the occurrence of the trend and then act accordingly (e.g., provide an alert, schedule a maintenance, etc.), thereby preventing the failure or fault and/or mitigating the loss of down time or decreased efficient operation of the cleaning chemical dispenser units.

### III. Exemplary System Architecture

### 1. Exemplary Analysis System

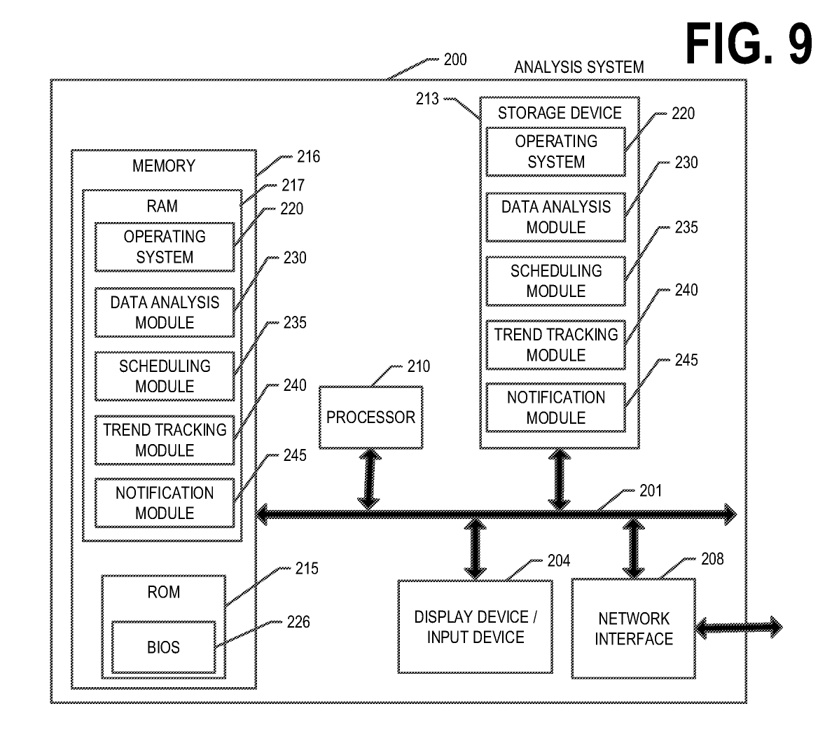

A analysis system 200 may be operated by and/or on behalf of an entity, organization, company, retail location, and/or the like operating an industrial cleaning device 100 and/or an organization, company, group, and/or the like that manufactures and/or provides maintenance for one or more industrial cleaning devices. FIG. 9 shows a schematic diagram of an example analysis system 200. In general, the term system may refer to, for example, one or more computers, computing devices, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the analysis system 200 may also include one or more communications interfaces for communicating with various computing entities, such as by communicating data, content, information, and/or similar terms used herein interchangeably that can be transmitted, received, operated on, processed, displayed, stored, and/or the like. For instance, the analysis system 200 may communicate with one or more user computing entities 10, one or more industrial cleaning devices 100, and/or one or more supplier systems 250.

In one embodiment, the analysis system 200 may include or be in communication with one or more processing elements 210 (also referred to as processors, processing circuitry, and/or similar terms used herein interchangeably) that communicate with other elements within the analysis system 200 via a bus 201, for example. As will be understood, the processing element 210 may be embodied in a number of different ways. For example, the processing element may be embodied as one or more complex programmable logic devices (CPLDs), microprocessors, multi-core processors, coprocessing entities, application-specific instruction-set processors (ASIPs), and/or controllers. Further, the processing element 210 may be embodied as one or more other processing devices or circuitry. The term circuitry may refer to an entirely hardware embodiment or a combination of hardware and computer program products. Thus, the processing element 210 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 210 may be configured for a particular use or configured to execute instructions stored in volatile or non-volatile media or otherwise accessible to the processing element. As such, whether configured by hardware or computer program products, or by a combination thereof, the processing element 210 may be capable of performing steps or operations according to embodiments of the present invention when configured accordingly.

In one embodiment, the analysis system 200 may further include memory or be in communication with memory 216, which may comprise non-volatile media (also referred to as non-volatile storage, memory, memory storage, memory circuitry and/or similar terms used herein interchangeably). In one embodiment, the non-volatile storage or memory 216 may include one or more non-volatile storage or memory media as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. For example, the non-volatile storage or memory may store code including data analysis module 230, scheduling module 235, trend tracking module 240, and/or notification module 245. The term database, database instance, database management system, and/or similar terms used herein interchangeably may refer to a structured collection of records or data that is stored in a computer-readable storage medium, such as via a relational database, hierarchical database, and/or network database. For example, the non-volatile storage or memory may comprise a map data database, load information database, schedule database, and/or the like.

In one embodiment, the memory 216 may further comprise volatile media (also referred to as volatile storage, memory, memory storage, memory circuitry and/or similar terms used herein interchangeably). In one embodiment, the volatile storage or memory may also include one or more volatile storage or memory media as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element. Thus, the databases, database instances, database management systems, data, applications, programs, program modules, scripts, source code, object code, byte code, compiled code, interpreted code, machine code, executable instructions, and/or the like may be used to control certain aspects of the operation of the analysis system 200 with the assistance of the processing element 210 and operating system 220.

In various embodiments, memory 216 can be considered primary memory such as RAM memory or other forms which retain the contents only during operation, or it may be a non-volatile memory, such as ROM, EPROM, EEPROM, FLASH, or other types of memory that retain the memory contents. In some embodiments, the disk storage may communicate with the processor 210 using an I/O bus instead of a dedicated bus. The memory 216 could also be secondary memory, such as disk storage, that stores a relatively large amount of data. The secondary memory may be a floppy disk, hard disk, compact disk, DVD, or any other type of mass storage type known to those skilled in the computer arts. The memory 216 may also comprise any application program interface, system, libraries and any other data by the processor to carry out its functions. ROM 215 is used to store a basic input/output system 226 (BIOS), containing the basic routines that help to transfer information/data between components of the analysis system 200, including the data analysis module 230, the scheduling module 235, the trend tracking module 240, the notification module 245, and/or the operating system 120.

In addition, the analysis system 200 includes at least one storage device 213, such as a hard disk drive, a floppy disk drive, a CD-ROM drive, or optical disk drive, for storing information/data on various computer-readable media, such as a hard disk, a removable magnetic disk, or a CD-ROM disk. As will be appreciated by one of ordinary skill in the art, each of these storage devices 213 is connected to the system bus 201 by an appropriate interface. It is important to note that the computer-readable media described above could be replaced by any other type of computer-readable media known in the art. Such media include, for example, memory sticks (e.g., USB memories), magnetic cassettes, flash memory cards, and digital video disks.

A number of program modules may be stored by the various storage devices and within RAM 217. Such program modules include the operating system 120, data analysis module 230, scheduling module 235, trend tracking module 240, and/or notification module 245. Those skilled in the art will appreciate that other modules may be present in RAM 217 to effectuate the various embodiments of the present invention. Furthermore, the functions of the data analysis module 230, scheduling module 235, trend tracking module 240, and/or notification module 245 need not be modular.

Also located within the analysis system 200 is a network interface 208, for interfacing and communicating with other elements of a computer network, such as by communicating data, content, information, and/or similar terms used herein interchangeably that can be transmitted, received, operated on, processed, displayed, stored, and/or the like. For instance, the analysis system 200 may be in communication with one or more user computing entities 10, one or more industrial cleaning devices 100, and/or one or more supplier systems 250. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the analysis system 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1x (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Various information/data can be received by the analysis system 200 via the network interface 208 and/or input/output device 204. This information/data may include operational data/information, shipping information for parts and/or supplies that were automatically ordered to address an expected fault condition, maintenance scheduling information, and/or the like. This input information/data may vary, however, depending on the configuration and informational requirements of the analysis system 200.

As mentioned above, the analysis system 200 also includes an input/output device 204 for receiving and displaying data. The analysis system 200 may include or be in communication with one or more input elements, such as a keyboard input, a mouse input, a touch screen/display input, audio input, pointing device input, joystick input, keypad input, and/or the like, as indicated by input/output device 204. The analysis system 200 may also include or be in communication with one or more output elements, as indicated by input/output device 204, such as audio output, video output, screen/display output, motion output, movement output, and/or the like.

In various embodiments, the analysis system 200 may be configured to analyze operational data/information corresponding to the operation of an industrial cleaning device 100. The analysis system 200 may be further configured to identify a known trend or anomaly in the operational data/information and trigger one or more actions based thereon.

In various embodiments, the analysis system 200 may be configured to receive input and/or information/data from or provide information/data to one or user computing entities 10, one or more industrial cleaning devices 100, and/or one or more supplier systems 250. The analysis system 200 may be configured to be in communication with one or more user computing entities 10, one or more industrial cleaning devices 100, and/or one or more supplier systems 250.

The analysis system 200 may also comprise, be associated with, or be in communication with various other internal systems, such as systems for coordinating technician visits to perform maintenance on one or more industrial cleaning devices 100, and a variety of other systems and their corresponding components.

Those skilled in the art will recognize that many other alternatives and architectures are possible and can be used to practice various embodiments of the invention. The embodiment illustrated in FIG. 9 can be modified in different ways or incorporated within a network and be within the scope of the invention. For example, one or more components of the analysis system 200 may be located remotely from other analysis system 200 components, such as in a distributed system. Furthermore, one or more of the components may be combined and additional components performing functions described herein may be included or associated with the analysis system 200. Thus, the analysis system 200 can be adapted to accommodate a variety of needs and circumstances.

### 2. Exemplary Industrial Cleaning Device

FIG. 2 provides a block diagram of an example industrial cleaning device 100. In various embodiments, the industrial cleaning device 100 may comprise one or more portions configured to perform cleaning functions. For example, if the industrial cleaning device 100 is a ware washer, the industrial cleaning device may comprise one or more nozzles for spraying dishware within the ware washer with wash fluid and/or rinse fluid. The industrial cleaning device 100 may further comprise one or more sensors configured to capture measurements of operational parameters. For example, the industrial cleaning device 100 may comprise one or more temperature sensors 110, one or more energy usage sensors 120, one or more flow meter sensors 130, and/or one or more other sensors 140. For example, the one or more sensors may be configured to capture measurements related to prewash temperature, wash temperature, rinse temperature, drying temperature, electricity usage, water usage, water flow through various portions of the industrial cleaning device 100, chemical/product usage (e.g., amount of detergent or other cleaning chemicals dispensed/used during operation), chemical/product concentration (e.g., concentration of detergent or other cleaning chemicals in prewash fluid, wash fluid, rinse fluid, and/or the like), and/or other operational parameters.

In various embodiments, the industrial cleaning device 100 may further comprise one or more controllers 150. The controller 150 may be configured to control the operation of the industrial cleaning device, receive operational data/information or measurements from one or more sensors (e.g., 110, 120, 130, 140), and/or the like. In various embodiments, the controller 150 may be a processing element that may be embodied as one or more complex programmable logic devices (CPLDs), microprocessors, multi-core processors, coprocessing entities, application-specific instruction-set processors (ASIPs), and/or controllers. For example, the controller 150 may be embodied as one or more other processing devices or circuitry. The term circuitry may refer to an entirely hardware embodiment or a combination of hardware and computer program products. Thus, the controller 150 may be embodied as integrated circuits, application specific integrated circuits (ASICs), field programmable gate arrays (FPGAs), programmable logic arrays (PLAs), hardware accelerators, other circuitry, and/or the like. As will therefore be understood, the controller 150 may be configured for a particular use or configured to execute instructions stored in volatile or non-volatile media or otherwise accessible to the controller. As such, whether configured by hardware or computer program products, or by a combination thereof, the controller 150 may be capable of performing steps or operations according to embodiments of the present invention when configured accordingly.

The industrial cleaning device 100 may further comprise non-volatile memory 170 and/or volatile memory 180. The non-volatile memory 170 and/or volatile memory 180 may be configured to store computer-readable instructions for operation of the industrial cleaning device 100, computer-readable instructions for capturing measurements of one or more operational parameters during operation of the industrial cleaning device 100, one or more captured measurements of operational parameters, and/or the like.

The industrial cleaning device 100 may further comprise a network interface 160 configured to communicate via at least one wired or wireless network. In various embodiments, the network interface 160 is configured to communicate via at least one communication protocol described above with respect to the analysis system 200. For example, the network interface 160 may be configured to provide, transmit, or communicate one or more captured measurements of operational procedures to the analysis system 200 (or user computing entity 10) via a wired or wireless network 50, 55. In some embodiments, the network interface 160 provides, transmits, or communicates one or more captured measurements of operational procedures to the analysis system 200 via a proprietary and/or secured network 55. In other embodiments, the network 55 may be a broadband network, cellular network, and/or other wired or wireless network. In various embodiments, the industrial cleaning device 100 is remotely located from the analysis system 200.

### 3. Exemplary Supplier System

In one embodiment, a supplier of parts and/or cleaning chemicals for the industrial cleaning device 100 may operate a supplier system 250. A supplier system 250 may include one or more components that are functionally similar to those of the analysis system 200. For example, in one embodiment, each supplier system 250 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, a supplier system 250 may communicate or interact with any number of analysis systems 200 via their respective communication interfaces. In some embodiments, the supplier system 250 and the analysis system 200 may be portions of the same server system. For example, if analysis system 200 is operated by a manufacturer of the industrial cleaning device 100, the manufacturer may also be the supplier of one or more parts and/or cleaning chemicals for the industrial cleaning device 100. As will be recognized, these architectures and descriptions are provided for exemplary purposes only and are not limiting to the various embodiments.

### 4. Exemplary User Computing Entity

In one embodiment, a user or a manager of the industrial cleaning device 100 (e.g., an employee or manager within the company, organization, and/or the like operating the industrial cleaning device) may operate a user computing entity 10. A user computing entity 10 may include one or more components that are functionally similar to those of the analysis system 200 and/or the supplier system 250. For example, in one embodiment, each user computing entity 10 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, a user computing entity 10 may communicate or interact with any number of analysis systems 200, and/or industrial cleaning devices 100 via their respective communication interfaces. For example, the user or manager of the industrial cleaning device may access a dashboard providing operational data/information related to one or more industrial cleaning devices 100. In some embodiments, the user computing entity 10 is physical connected to the industrial cleaning device 100. For example, the user computing entity 10 may be a touchscreen tablet or the like mounted to the exterior of an industrial cleaning device 100. In another embodiment, the user computing entity 10 may be integrally connected to the industrial cleaning device 100. For example, a processing element, memory, and/or network interface of the user computing entity 10 may be configured to act as the controller 150, memory 170, 180, and/or network interface 160, respectively. As will be recognized, these architectures and descriptions are provided for exemplary purposes only and are not limiting to the various embodiments.

### IV. Computer Program Products, Methods, and Computing Entities

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described above with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### V. CONCLUSION

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims Although specific terms are employed herein, they are used in a generic and descriptive sense only and not for purposes of limitation.

1. A method for providing predictive maintenance for an industrial cleaning device, the method comprising:
receiving operational data indicating operational parameters associated with the industrial cleaning device during operation thereof;
identifying a trend in the operational data;
determining that a particular fault event associated with the industrial cleaning device is likely to occur within a particular time frame; and
providing an alert indicating that the particular fault event is likely to occur within the particular time frame.

2. The method of claim 1 further comprising, in response to the determining, ordering at least one of a part or a supply for the industrial cleaning device wherein the ordered part or supply is selected based on the particular fault event.

3. (canceled)

4. The method of claim 1 further comprising, in response to the determining, scheduling maintenance for the industrial cleaning device to prevent the fault event, wherein the maintenance is scheduled to occur prior to the end of the particular time frame.

5. (canceled)

6. The method of claim 1 further comprising, in response to the determining, providing information relating to a short term solution for the particular fault event.

7. The method of claim 6, wherein the short term solution is configured to extend the particular time frame.

8. The method of claim 1 further comprising, in response to the determining, providing one or more training resources configured to teach one or more operators of the industrial cleaning device at least one of: (a) how to perform a maintenance to the industrial cleaning device in related to the particular fault event or (b) how to prevent the occurrence of a future fault event.

9. The method of claim 1, wherein the particular time frame is a period of time for which it is expected the industrial cleaning device will continue to function at an acceptable quality level before the particular fault condition causes the quality of the industrial cleaning device to decrease.

10. The method of claim 1, wherein the operational data comprises at least one of a prewash temperature, wash temperature, a rinse temperature, a dry temperature, a product concentration, an electricity usage, or a water usage.

11. A system comprising:
at least one computer-readable storage medium storing computer-readable program code portions therein, at least one processor, and at least one communications interface, the system being in communication with at least one industrial cleaning device via the communications interface, the industrial cleaning device having operational sensors configured to capture operational data, the computer-readable program code portions configured to, when executed by the at least one processor, cause the system to at least:
receive operational data indicating operational parameters associated with the industrial cleaning device during operation thereof;
identify a trend in the operational data;
determine that a particular fault event associated with the industrial cleaning device is likely to occur within a particular time frame; and
provide an alert indicating that the particular fault event is likely to occur within the particular time frame.

12. The system of claim 11, wherein the at least one industrial cleaning device is remotely located.

13. The system of claim 11, wherein the computer-readable program code portions are further configured to, when executed by the at least one processor, cause the system to at least, in response to the determining, order at least one of a part or a supply for the industrial cleaning device, wherein the ordered part or supply is selected based on the particular fault event.

14. (canceled)

15. The system of claim 11, wherein the computer-readable program code portions are further configured to, when executed by the at least one processor, cause the system to at least, in response to the determining, schedule maintenance for the industrial cleaning device to prevent the fault event, wherein the maintenance is scheduled to occur prior to the end of the particular time frame.

16. (canceled)

17. The system of claim 11, wherein the computer-readable program code portions are further configured to, when executed by the at least one processor, cause the system to at least, in response to the determining, provide information relating to a short term solution for the particular fault event.

18. The system of claim 17, wherein the short term solution is configured to extend the particular time frame.

19. The system of claim 11, wherein the computer-readable program code portions are further configured to, when executed by the at least one processor, cause the system to at least, in response to the determining, provide one or more training resources configured to teach one or more operators of the industrial cleaning device at least one of: (a) how to perform a maintenance to the industrial cleaning device in related to the particular fault event or (b) how to prevent the occurrence of a future fault event.

20. The system of claim 11, wherein the particular time frame is a period of time for which it is expected the industrial cleaning device will continue to function at an acceptable quality level before the particular fault condition causes the quality of the industrial cleaning device to decrease.

21. The system of claim 11, wherein the operational data comprises at least one of a prewash temperature, wash temperature, a rinse temperature, a dry temperature, a product concentration, an electricity usage, or a water usage.

22. A computer program product comprising at least one non-transitory computer-readable storage medium having computer-readable program code portions stored therein, the computer-readable program code portions configured to, when executed by at least one processor, cause the processor to at least:
receive operational data indicating operational parameters associated with the industrial cleaning device during operation thereof;
identify a trend in the operational data;
determine that a particular fault event associated with the industrial cleaning device is likely to occur within a particular time frame; and
provide an alert indicating that the particular fault event is likely to occur within the particular time frame.

23. A method for providing predictive maintenance for an industrial cleaning device, the method comprising:
receiving operational data indicating operational parameters associated with the industrial cleaning device during operation thereof;
detecting an anomaly in the operational data;
determining if the anomaly is associated with a known trend; and
flagging at least a portion of the operational data as including an anomaly.

24. The method of claim 23, wherein when it is determined that the anomaly is associated with a known trend, the method further comprising:
determining that a particular fault event is likely to occur in a particular time frame; and
in response to determining that the particular fault event is likely to occur, at least one of:
ordering at least one of a part or a supply for the industrial cleaning device, scheduling maintenance for the industrial cleaning device to prevent the fault event,
providing information relating to a short term solution for particular fault event,
providing one or more training resources associated with the particular fault event, or
providing a notification that the fault event is likely to occur in the particular time frame.

25. The method of claim 23, wherein when it is determined that the anomaly is not associated with a known trend, the method further comprising:
analyzing operational data for the industrial cleaning device to determine if any other anomalies are present in the operational data.

26. The method of claim 25, further comprising, in response to not detecting any further anomalies in the operational data, determining that the anomaly is due to external factors.

27. The method of claim 25, further comprising in response to detecting one or more further anomalies in the operational data, monitoring the operational data to determine if a new trend becomes apparent.

28. The method of claim 23, wherein the operational data comprises at least one of a prewash temperature, wash temperature, a rinse temperature, a dry temperature, a product concentration, an electricity usage, or a water usage.

29. A system comprising:
at least one computer-readable storage medium storing computer-readable program code portions therein, at least one processor, and at least one communications interface, the system being in communication with at least one industrial cleaning device via the communications interface, the industrial cleaning device having operational sensors configured to capture operational data, the computer-readable program code portions configured to, when executed by the at least one processor, cause the system to at least:
receive operational data indicating operational parameters associated with the industrial cleaning device during operation thereof;
detect an anomaly in the operational data;
determine if the anomaly is associated with a known trend; and
flag at least a portion of the operational data as including an anomaly.

30. The system of claim 29, wherein the computer-readable program code portions are further configured to, when executed by the at least one processor, cause the system to at least:
responsive to determining that the anomaly is associated with a known trend, determine that a particular fault event is likely to occur in a particular time frame; and
in response to determining that the particular fault event is likely to occur, at least one of:
order at least one of a part or a supply for the industrial cleaning device,
schedule maintenance for the industrial cleaning device to prevent the fault event,
provide information relating to a short term solution for particular fault event,
provide one or more training resources associated with the particular fault event, or
provide a notification that the fault event is likely to occur in the particular time frame.

31. The system of claim 29, wherein the computer-readable program code portions are further configured to, when executed by the at least one processor, cause the system to at least:
responsive to determining that the anomaly is not associated with a known trend, analyze the operational data for the industrial cleaning device to determine if any other anomalies are present in the operational data.

32. The system of claim 31, wherein the computer-readable program code portions are further configured to, when executed by the at least one processor, cause the system to at least, in response to not detecting any further anomalies in the operational data, determining that the anomaly is due to external factors.

33. The system of claim 31, wherein the computer-readable program code portions are further configured to, when executed by the at least one processor, cause the system to at least, in response to detecting one or more further anomalies in the operational data, monitoring the operational data to determine if a new trend becomes apparent.

34. The system of claim 29, wherein the operational data comprises at least one of a prewash temperature, wash temperature, a rinse temperature, a dry temperature, a product concentration, an electricity usage, or a water usage.

35. The system of claim 29 wherein the at least one industrial cleaning device is remotely located.

36. A computer program product comprising at least one non-transitory computer-readable storage medium having computer-readable program code portions stored therein, the computer-readable program code portions configured to, when executed by at least one processor, cause the processor to at least:
receive operational data indicating operational parameters associated with the industrial cleaning device during operation thereof;
detect an anomaly in the operational data;
determine if the anomaly is associated with a known trend; and
flag at least a portion of the operational data as including an anomaly.
